(19) United States
(12) Patent Application Publication
(10) Pub. No.: US 2005/0122836 A1
(43) Pub. Date: Jun. 9, 2005

(54) Stand mixer with control panel

(75) Inventors: Kenneth C. Boyle, Newton, IA (US); Annette D. Bravard, Massillon, OH (US); Rob P. Brueckner, Johnston, IA (US); Brian K. Linstedt, Ostrander, OH (US); John J. Knittle, Westerville, OH (US)

Correspondence Address: MCKEE, VOORHEES & SEASE, P.L.C.;ATTN: MAYTAG, 801 GRAND AVENUE, SUITE 3200, DES MOINES, IA, 50309-2721, US

(73) Assignee: Maytag Corporation, Newton, IA (US)

(21) Appl. No.: 10/729,760

(22) Filed: Dec. 5, 2003

(51) Int. Cl. B01F 7/00

(52) U.S. Cl. 366/197; 366/206

(57) ABSTRACT

A stand mixer having a mixer housing with an upper surface and a lower surface is provided with a control panel. The stand mixer also has a motor within the mixer housing operably connected with a drive shaft extending through the lower surface. The stand mixer further has a speed indicator located on the upper surface of the mixer housing. The motor is started by the user actuating a power button and the speed of the motor is adjustable by the user rotating a dial. A method of using a stand mixer includes the step of adjusting a rotary dial to select a motor speed. The method further includes the step of actuating the power button for starting a motor on the stand mixer.

### BACKGROUND OF THE INVENTION

Household appliances such as stand mixers generally include control panels located upon the side of the mixer. These control panels typically are not illuminated. With these stand mixers, there is the inconvenience of accessing the control panel from the side, and a lack of a quickly recognizable indication of the speed of the mixer.

Therefore, a primary objective of the present invention is the provision of a stand mixer having an improved speed selection mechanism.

Another objective of the present invention is a stand mixer having a control panel with an illuminated speed indicator.

In addition, the stand mixers of the prior art have not utilized the top portion of the upper surface of the mixer house. This location provides the advantages of being readily accessible by either hand of the user and good visibility. Accordingly, another objective of the present invention is a stand mixer having a control panel on the top of the stand mixer.

Still another objective of the present invention is a stand mixer having an improved speed indicator.

A further objective of the present invention is a provision of an improved power switch which allows for a stand mixer being moved from a standby mode or sleep mode, on, and off.

A still further objective of the invention is the provision of an improved stand mixer having a rotatable dial which is easy to adjust for a plurality of mixer speeds.

A still further objective of the present invention is the provision of an improved stand mixer design which is economically manufactured and durable in use.

These and other objectives will become apparent from the following description of the invention.

### BRIEF SUMMARY OF THE INVENTION

The foregoing objectives may be achieved by the stand mixer of the present invention which has a mixer housing with an upper surface and a lower surface. The stand mixer also has a motor within the mixer housing with a downwardly extending drive shaft. The stand mixer also has a speed selection dial and a speed indicator located on the upper surface of the mixer housing. The motor is started by the user actuating the power switch and the speed of the motor is adjustable by the user rotating the speed dial. An LED is automatically illuminated corresponding to the selected motor speed.

### BRIEF DESCRIPTION OF THE DRAWINGS

FIG. 1 is a front perspective view of a stand mixer of the present invention with a bowl and mixing implement positioned for use with the mixer.

FIG. 2 is a rear perspective view of the stand mixer without the bowl and mixing implement.

FIG. 3 is a cross sectional view of the upper housing of the stand mixer illustrating the location of the control device.

FIG. 4 is an exploded view of the control panel in alignment with the control device.

FIG. 5 is a partially assembled view of components making up the control device, power button, and radial dial.

FIG. 6 is a partially assembled front view of components making up the control device.

FIG. 7 is a partially assembled rear view of components making up the control device.

FIG. 8 is an electrical block diagram of the present invention.

### DETAILED DESCRIPTION OF THE PREFERRED EMBODIENT

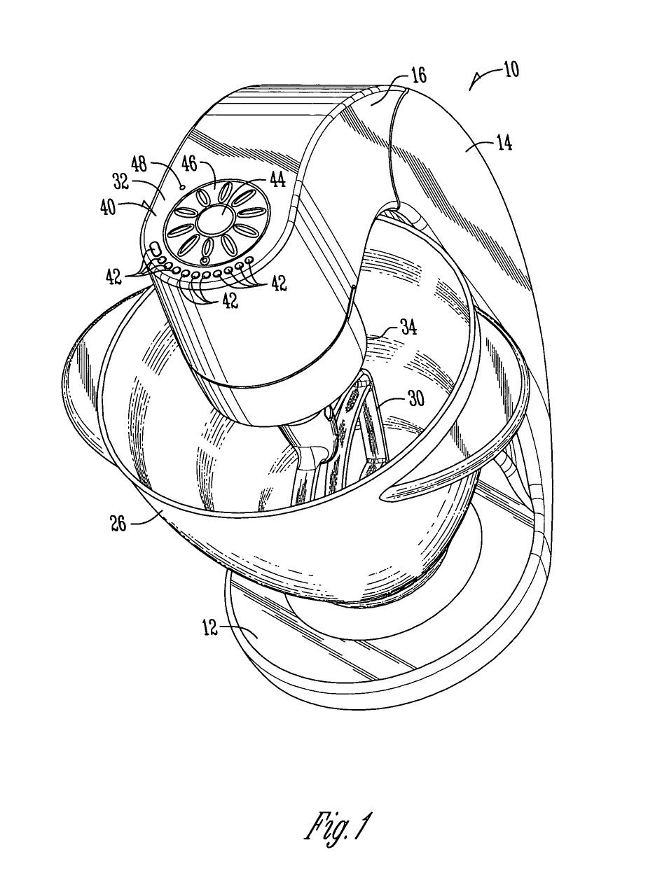

The stand mixer of the present invention is generally designated in the drawings by the reference numeral 10. As seen in FIG. 1, the stand mixer 10 includes a mixer base 12, a lower housing 14, and an upper housing 16. The lower housing 14 has a back panel 18. The upper housing 16 is pivotally attached to the lower housing 14 and may pivot about a horizontal axis by a user actuating a pivot release button 20.

The upper housing 16 has a top portion 32 and the bottom portion 34. A control panel 40 includes speed indicator lenses 42, a power button 44, and a radial dial 46 on the top portion 32 of the housing 16. The speed lenses 42 are oval and circle shaped and are labeled on/off and 1-10. The speed lenses 42 are positioned adjacent the radial dial 46 along a radius from its axis of rotation. The oval lens 42 is labeled on/off and circle lenses are labeled 1-10 with 1 being the slowest speed and 10 being the highest speed. Also upon the control panel 40 is a power light or readiness indicator 48. The readiness indicator 48 is off when the mixer 10 is completely off, is blinking when the stand mixer 10 is in a standby mode, and is illuminated when the mixer 10 is on.

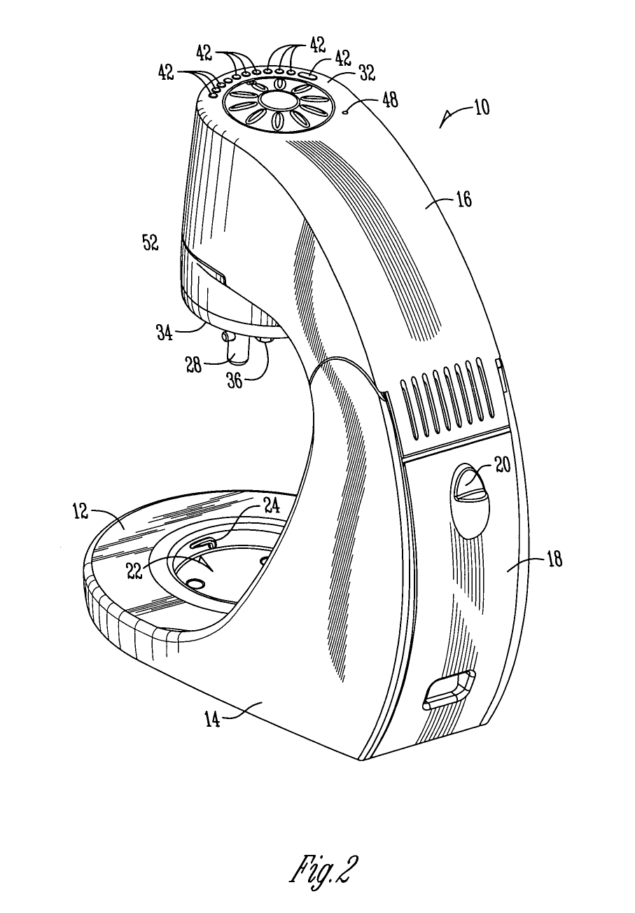

As seen in FIG. 2, the mixer base 12 defines a bowl hollow 22. Bowl locking members 24 exist within the bowl hollow 22. A bowl 26 can be inserted into the bowl hollow 22 and twisted to engage the bowl locking members 24 such that the bowl 26 does not rotate within the bowl hollow 22.

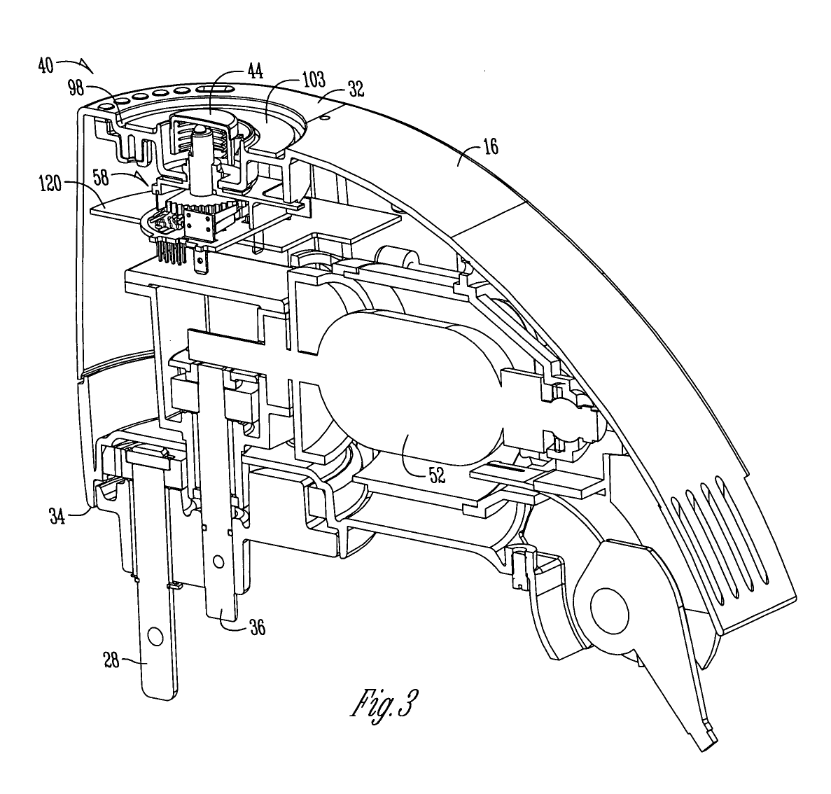

As seen in FIG. 3, a motor 52 is operatively mounted inside the upper housing 16. The motor 52 is operably connected to a first output shaft 28 and a second output shaft 36. The first output shaft 28 extends from the bottom portion 34 of the upper housing 16 and a mixing implement 30 may be attached to the output shaft 28. A second output shaft 36 extends from the bottom portion 34 of the upper housing 16 and may be used for attaching a variety of different accessories (not shown) such as vegetable slicers, pasta extruders, and food grinders.

As further illustrated by FIG. 3, the location of a control device 58 is directly under the control panel 40. The control device 58 is provided with input from a user by the on/off button 44 and the rotary dial 46 which turns upon a hollow 98 of the upper housing 16.

The on/off or power button 44 is a non-latching voluntary tactile switch. The power button 44 controls the power state of the mixer motor 52. In the preferred embodiment, the power button 44 is located in the center of the rotary or radial dial 46. The power button 44 is used to alternatively start and stop the motor 52. To start the motor 52, the user momentarily pushes the power button 44. The motor will start with the depression of the power button 44. Releasing the power button 44 has no effect. To stop the mixer motor, the user momentarily pushes the power button 44, thereby placing the stand mixer 10 in the standby mode. The motor 52 will stop with the depression of the power button 44. Releasing the power button has no effect. Repeatedly pushing the power button 44 alternates the stand mixer 10 between the standby mode and the on mode.

The radial dial 46 is used to adjust the speed of the motor 52. The rotary dial 46 when rotated counter-clockwise increases the speed and when moved in a clockwise direction decreases the speed.

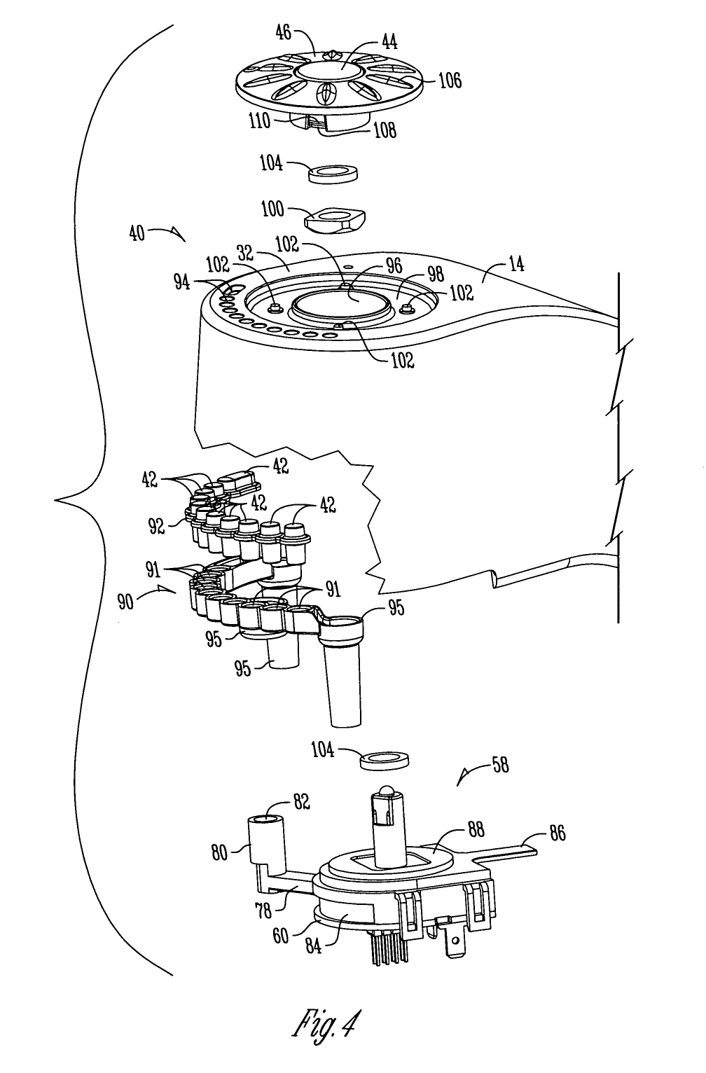

An exploded view of the control panel 40 in alignment with the control device 58 is seen in FIG. 4. The control panel 40 includes speed indicator lenses 42, a power button 44, and a radial dial 46 on the top portion 32 of the housing 16.

The control device 58 has a base 60, a casing 86 attached to the base 60, and a moveable cover 84 moving with an opening defined by the base 60 and the casing 86. The control device 58 also has an arm 78 extending from an opening in the cover 84. An illuminator casing 80 is attached to the arm 78, and within the illuminator casing 80 is an illuminator 82. The illuminator 82 is preferably a light emitting diode or LED. A grommet 88 is placed upon the casing 86 for sealing the inner workings of the control device 58. The control device 58 is connected to the upper housing 16 by a nut 100 which is separated from other components by spacers 104.

A shroud 90 is used to guide light from the illuminator 82 through the lens 42. The lenses are joined together by a web 92. The web 92 is sufficiently thin to prevent bleed over from one light lens 42 to the next light lens 42 while the illuminator 82 is in axial alignment with a lens 42. The shroud 90 is also designed to minimize bleed over from one lens to the next. The shroud 90 separates the illuminator 82 from the lens by a distance. The shroud 90 is formed from an opaque plastic material with through-holes 91 to accept the lenses 42. When the illuminator 82 is aligned with a through-hole 91, the light from the illuminator 82 is channeled to the lens 42. The lens 42 is fit into the lens opening 94 in the housing 16 after being placed within the shroud 90. The shroud and lens assembly is attached to the upper housing 16 by screws (not shown) placed through shroud connector assembly 95 and into the upper housing 16.

As further seen in FIG. 4, the upper housing 16 has a chamber 96 and a hollow or recess 98 defined in the top portion 32 of upper housing 16. The control device 58 is placed within the chamber 96 and attached to the upper housing by nut 100. The radial dial 46 is positioned within the top upper housing hollow 98 and positioned to engage the control device 58. The radial dial 46 moves about the hollow 98 upon a plastic washer as seen in FIG. 3; alternatively, the radial dial 46 may move about the hollow 98 upon metal glides 102. The power button 44 is placed over the chamber 96 and positioned to engage the control device 58.

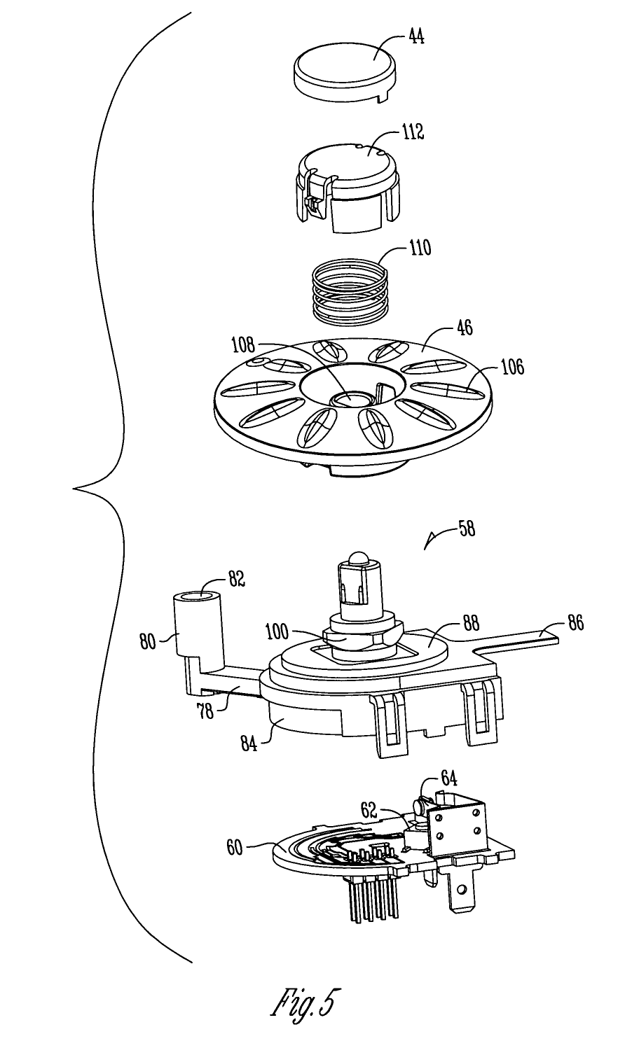

FIG. 5 displays a partially assembled view of components making up the control device 58, radial dial 46, and power button 44. The control device casing 86 may be separated from the base 60. Upon the base 60 is located an actuator or power switch 62 responsive to the power button 44. The base 60 also functions as a control board. The base therefore has circuitry relaying signals from the power switch 62 to the motor 52, readiness indicator 48, and illuminator 82.

The radial dial 46 has a soft touch insert 106 that allows for slight compression of the radial dial 46 by user and for comfortable movement of the dial 46 by the user. The rotary dial 46 attaches to the control device 58 by having a female structure 108 that engages the control device 58. A spring 110 is placed within the rotary dial 46 and held in place by a cap 112 that attaches to the rotary dial 46. The power button 44 is attached to the top of the cap 112. The spring 110 biases the power button 44 to a raised position.

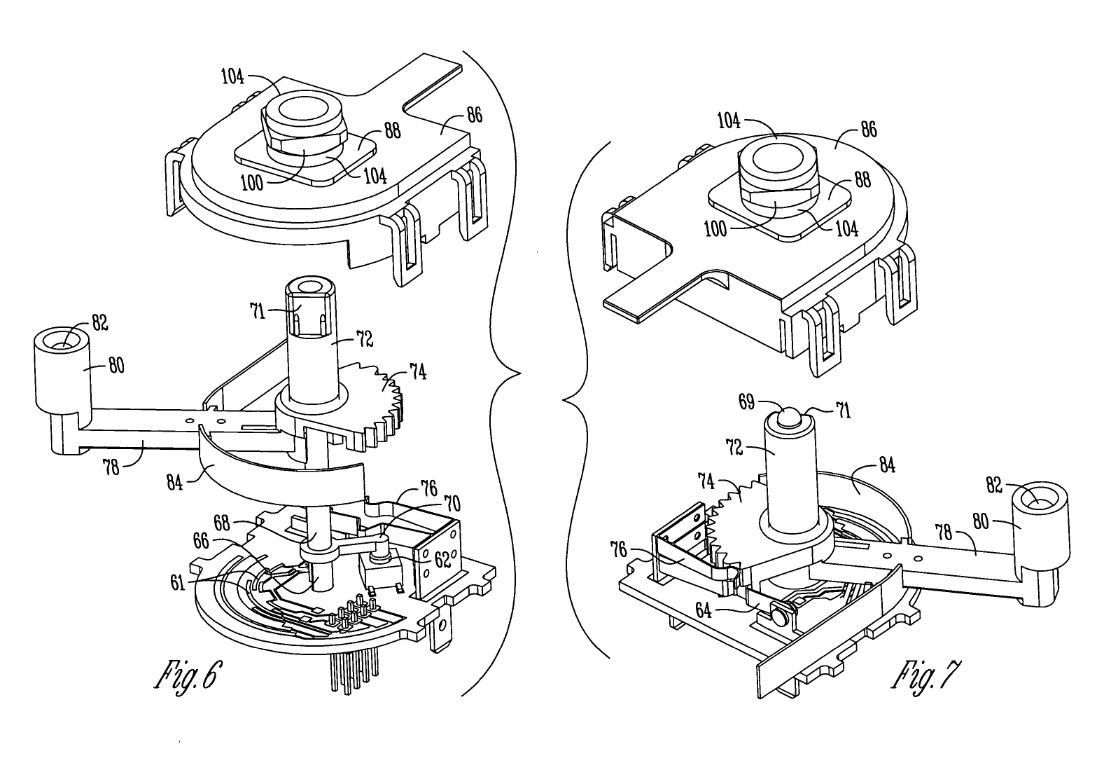

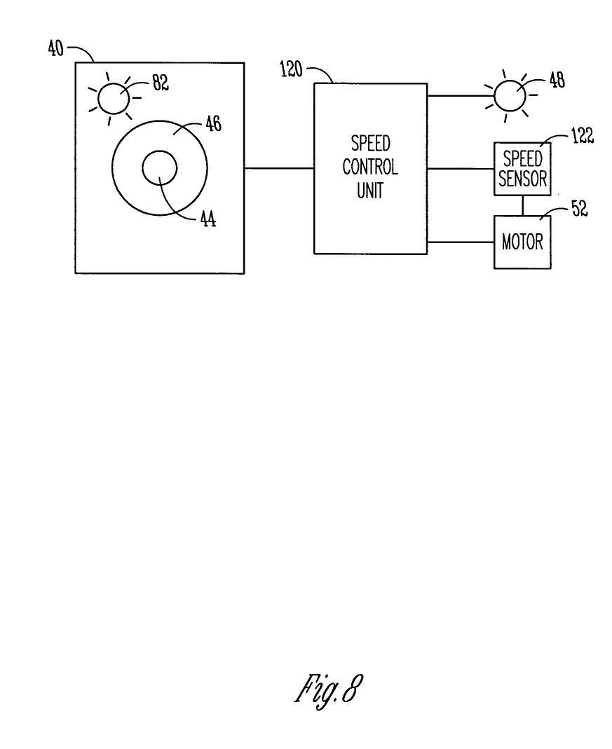

FIGS. 6 and 7 illustrate partially assembled views of components making up the control device 58. FIG. 6 is a front perspective view of the mechanical structure which communicates user movement onto the power button 44 into on/off control of the mixer 10. FIG. 7 is a rear perspective view focusing upon the mechanical structure which communicates user movement about the radial dial 46 to the motor 52 speed control.

As seen in FIG. 6, the control device 58 has a shaft 66 abutting the control base 60. Upon the shaft is a first member 68. The first member 68 has a top end 69 which is adjacent the power button 44 and a second end which has a first member extension 70 attached to it. The first member extension 70 is in axial alignment with the actuator 62 such that compression of the first end 69 of the first member 68 by the power button 44 moves the first member extension 70 to compress the power switch 62.

As seen in FIGS. 6 and 7, the second member 72 surrounds both the shaft 66 and the first member 68. The second member 72 is attached to the radial dial 46 by male structure 71 that engages the female structure 108. The second member 72 has a second member geared extension 74 that contacts a leaf spring 76. In this configuration, engagement of the geared extension 74 creates detents associated with each available motor speed as indicated by lenses 42. A wiper (not shown) engages printed circuit board traces 61 on base 60 to create a signal adjusting the motor 52 speed.

A simple block diagram is provided in FIG. 8. The control panel or user interface 40 has a power button 44. The illuminator 82 is powered when the power button 44 is engaged. The user interface 40 sends a signal to the speed control unit 120 which controls the readiness indicator 48 and the motor 52. Additionally, a speed sensor 122 provides feedback to the speed control unit 120 of the speed of the motor 52.

In use, rotation of the rotary dial 46 from the off position to any one of the available motor speeds causes contact 64 to move from an open to a closed state. This action places the stand mixer 10 in the standby mode. The user then evaluates the motor speed by a observing the speed indicator lenses 42 located on the top portion 32 of upper housing 16. The user may adjust the speed control unit by use of the rotary dial 46 to select any one of a plurality of speeds. The user may also evaluate the readiness of the stand mixer using the readiness indicator 48. The readiness indicator 48 indicates whether the stand mixer is in an off mode, a standby mode, or an on mode. The user changes the mode of the stand mixer by repeatedly pushing the power button 44 to move the stand mixer from on mode to a standby mode, and back to an on mode.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A stand mixer with control panel, the stand mixer comprising:
a mixer housing having an upper surface and a lower surface;
a motor within the mixer housing operably connected to a rotatable output shaft; and
a control panel on the mixer housing having a rotary dial adjustable by the user for controlling the motor and a power button actuable by a user for starting the motor located in the center of the rotary dial.

2. The stand mixer of claim 1 further comprising a speed indicator having a plurality of speed locations.

3. The stand mixer of claim 2 wherein the speed indicator includes a lens at the plurality of speed locations.

4. The stand mixer of claim 2 wherein the speed indicator is positioned radially from an axis of rotation of the rotary dial.

5. The stand mixer of claim 2 further comprising an illuminator wherein movement of the rotary dial causes the illuminator to be selectively positioned beneath one of the plurality of speed locations.

6. The stand mixer of claim 5 wherein the illuminator is a light emitting diode.

7. The stand mixer of claim 5 further comprising a pivotal arm attached to the rotary dial and supporting the illuminator, the pivotal arm moveably positioned beneath the plurality of speed locations.

8. The stand mixer of claim 5 wherein a shroud aligns with the illuminator for controlling direction of light from the illuminator.

9. The stand mixer of claim 3 wherein the lenses at the plurality of speed locations are joined by a web, the web being sufficiently thin to minimize light travel between the lens.

10. The stand mixer of claim 1 further comprising an indicator light for displaying readiness.

11. The stand mixer of claim 1 wherein the control panel is positioned on the upper surface of the mixer housing.

12. A method of controlling operation of a stand mixer, the method comprising:
adjusting a rotary dial to select a motor speed; and
actuating a power button located at the center of the rotary dial for starting a motor on the stand mixer.

13. The method of claim 12 further comprising lighting one of a plurality of lights located on an upper surface of the stand mixer to indicate the motor speed.

14. The method of claim 12 further comprising illuminating a light to indicate the operational mode of the stand mixer.

15. The method of claim 12 further comprising rotating the rotary dial from an off position for bringing the motor on the stand mixer to a standby mode.

16. The method of claim 12 further comprising actuating a power button for stopping the motor on the stand mixer thereby placing the stand mixer in a standby mode.

17. The method of claim 12 further comprising rotating the rotary dial to an off position thereby bringing the stand mixer to an off mode.

18. A stand mixer with control panel, the stand mixer comprising:
a mixer housing having an upper surface and a lower surface;
a motor within the mixer housing operably connected to a rotatable output shaft;
a control panel on the mixer housing engaging a power switch and a speed selector;
a speed indicator located on the upper surface of the stand mixer to indicate motor speed.

19. The stand mixer of claim 18 wherein the speed indicator includes a plurality of speed locations.

20. The stand mixer of claim 19 wherein the speed indicator includes a lens at the plurality of speed locations.

21. The stand mixer of claim 20 further comprises an illuminator positioned beneath the plurality of speed locations.

22. The stand mixer of claim 21 wherein the illuminator is a light emitting diode.

23. The stand mixer of claim 18 wherein the control panel is positioned on the upper surface of the mixer housing.

24. A stand mixer comprising:
a mixer housing having an upper surface and a lower surface;
a motor within the housing operably connected to a rotatable output shaft; and
a control panel utilized to control the motor, the control panel positioned on a top portion of the upper surface of the mixer housing.

25. The stand mixer of claim 24 wherein the control panel has a speed indicator, a power button actuable by a user for starting the motor, and a rotary dial adjustable by the user for controlling the motor.

26. The stand mixer of claim 25 wherein the power button is located in the center of the rotary dial.
